(19) United States
(12) Patent Application Publication
(10) Pub. No.: US 2026/0081955 A1
(43) Pub. Date: Mar. 19, 2026

(54) POLICY AS CODE BASED ON A UNIFIED RESOURCE MODEL OF CLOUD INFRASTRUCTURE

(71) Applicant: Pulumi Corporation, Seattle, WA (US)

(72) Inventors: Patrick Duncan Gavlin, Seattle, WA (US); Craig Symonds, Seattle, WA (US); Levi Michael Blackstone, Sandy, UT (US); John Joseph Duffy, Greenbank, WA (US); Tyler Joseph Dunkel, Chicago, IL (US); Alejandro Andres Cotroneo, Bahia Blanca (AR); Cleve Wayne Littlefield, Seattle, WA (US); Meagan Kari Cojocar, Seattle, WA (US); Lucas James Hoban, Seattle, WA (US)

(21) Appl. No.: 19/331,341

(22) Filed: Sep. 17, 2025

Related U.S. Application Data
(60) Provisional application No. 63/696,361, filed on Sep. 18, 2024.

(51) Int. Cl. H04L 9/40

(52) U.S. Cl. CPC H04L 63/20; H04L 63/10

(57) ABSTRACT

A system enforces policies based on a computing infrastructure of a cloud platform. The system stores a policy as code specification of a policy associated with computing resources of a cloud infrastructure of a cloud platform. The system stores metadata describing a set of computing resources of the cloud infrastructure. The metadata is represented using a uniform resource model of computing resources. The system executes the policy as code specification against the metadata and determines a policy violation based on execution. The policy violation indicates a failure to satisfy at least a policy constraint of the policy. The system determines a modification to the uniform cloud resource model representing the set of computing resources. The system executes a modified uniform cloud resource model that causes changes to the set of computing resources that remediate the policy violation.

### CROSS REFERENCE TO RELATED APPLICATION

This application claims the benefit under 35 U.S.C. § 119(e) of U.S. Provisional Patent Application Ser. No. 63/696,361, filed on Sep. 18, 2024, which is incorporated by reference in its entirety.

### TECHNICAL FIELD

The disclosed embodiments generally relate to management of cloud infrastructure and more specifically to management of policy as a code based on a unified resource model of cloud infrastructure.

### BACKGROUND

A computing infrastructure is the foundation of an information technology (IT) service and may include various resources hosted by third-party cloud computing services. Third-party cloud computing services such as Amazon Web Services (AWS™), Azure™, Google Cloud™, Kubernetes™, and others provide various cloud computing resources to individuals or organizations on demand. Recently, the number of cloud platforms has grown. For example, there are over hundred cloud platforms available, each cloud platforms with several different types of resources available. As a result, configuring resources on cloud platforms is challenging. Furthermore, organizations enforce certain policies based on their infrastructure. A policy may apply to a resource or to a container of resources. Enforcing policies may require significant efforts since resources may be added, removed, or modified by various users by using various mechanisms such as scripts, commands, application programming interfaces (APIs).

### SUMMARY

A system enforces policies based on a computing infrastructure of a cloud platform. The system stores a policy as code (PaC) specification of a policy associated with computing resources of a cloud infrastructure of a cloud platform. The PaC specification comprises a set of policy constraints. The system stores metadata describing a set of computing resources of the cloud infrastructure. The metadata is represented using a uniform resource model of computing resources. The system executes the PaC specification against the metadata describing the set of computing resources.

The system determines a policy violation based on execution of the PaC specification. The policy violation indicates a failure to satisfy a policy constraint of the policy. The system determines a modification to the uniform cloud resource model representing the set of computing resources. The modification is recommended for remediation of the policy violation. The system executes a modified uniform cloud resource model that causes changes to the set of computing resources that remediate the policy violation.

Embodiments perform steps of the methods disclosed hereon. Embodiments include computer readable storage media storing instructions for performing the steps of the above method. Embodiments include computer systems that comprise one or more computer processors and a computer readable storage medium store instructions for performing the steps of the above method.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 shows a diagram of a system environment of a desired state configuration system for configuring computing infrastructure on cloud platforms based on natural language descriptions received from users, according to example embodiments.

FIG. 2 shows a block diagram of the multi-language component management module, according to example embodiments.

FIG. 3A shows an example data structure of a multi-language component, according to example embodiments.

FIG. 3B shows an example data structure of a schema for the multi-language component, according to example embodiments.

FIG. 3C shows an example data structure of a software development kit (SDK) generated based on the multi-language component, according to example embodiments.

FIG. 4 shows the overall architecture of the system and interactions between components, according to an embodiment.

FIG. 5 is a flowchart illustrating the process for applying updates while enforcing policies, according to an embodiment.

FIG. 6 is a flowchart illustrating the process for discovering resources while enforcing policies, according to an embodiment.

FIG. 7 is a flowchart illustrating the process for execution of policies, according to an embodiment.

FIG. 8 shows a screenshot of a user interface displaying policy violations of an organization, according to an embodiment.

The figures depict various embodiments of the present technology for purposes of illustration only. One skilled in the art will readily recognize from the following description that other alternative embodiments of the structures and methods illustrated herein may be employed without departing from the principles of the technology described herein.

### DETAILED DESCRIPTION

Due to an increase in the number of cloud platforms available as well as increase in the number of resources available in each cloud platform, it is challenging for teams working with cloud platforms to configure cloud infrastructure resources. Use of IaC (Infrastructure as code) improves user experience with managing complexity of infrastructure. The system allows users to specify policies as code (PaC). A policy may be a security policy, for example, specifying whether certain resources can be accessed by certain users or groups of users. For example, a policy may ensure that storage is not publicly accessible over the Internet or that virtual machines must have a firewall. Policies may be enforced as either advisory, which prints a warning message the resource violates the policy; or as mandatory, which prevents a resource deployment if it violates the policy. A policy may be resource validation policy that validates inputs of individual resources in a stack before the resource is created or modified. A policy may be stack validation policy that validates outputs of all resources in the stack after all resources have been created or modified.

An IaC program is deployed to a stack. A stack is an isolated, independently configurable instance of an IaC program. Stacks may be used to denote different phases of development (such as development, staging, and production) or feature branches (such as feature-x-dev). A project can have multiple stacks.

A policy contains specific logic that an organization would like to enforce. For example, an organization may implement policies to prevent the creation of public, world-readable storage objects. or prevent the creation of a virtual machine without the proper security groups in-place.

The system allows policies to be written as validation functions that are evaluated against resources in a stack or account. A validation function may call reportViolation to indicate that the associated resource is in violation of the policy.

The system uses PaC to provide visibility into compliance issues across an entire cloud footprint regardless of how they were created. The system executes policies whenever a scanned resource changes or the policy configuration is updated. The system may display policy violations via a user interface, for example, a dashboard.

Following is an example, of policy as code specified using Python. Similar example can be provided using syntax of other programming languages such as TypeScript. The following policy disallows public-read or public-read-write access on a cloud resource such as an S3 bucket. The enforcement is specified as mandatory, i.e., the policy is required to be enforced. Accordingly, the system blocks an update that may result in violation of this policy.
def s3_no_public_read_validator(args: ResourceValidationArgs, report_violation: ReportViolation):
   if args.resource_type==“aws:s3/bucket:Bucket”and “acl” in args.props:
      acl=args.props[“acl”]
      if acl==“public-read” or acl==“public-read-write”:
         report_violation(“Public-read or public-read-write on an S3 bucket not allowed.”)
s3_no_public_read=ResourceValidationPolicy(
   name=“s3-no-public-read”,
   description=“Prohibits setting the publicRead or publicReadWrite permission on AWS S3 buckets.”,
   enforcement_level=EnforcementLevel.MANDATORY,
   validate=s3_no_public_read_validator,
)

The system allows use of Policy as Code to express business or security rules as functions that are executed against resources in their stacks or accounts. Then system allows administrators to apply these rules to particular stacks or accounts within their organization. When policies are executed as part of a deployment, if the system detects a policy violation, the system may gate or blocks that update from proceeding. The system is able to process policies specified using the syntax of a programming language, for example, TypeScript/JavaScript (Node.js) or Python. A policy may be specified via a PaC specification specified using a programming language that is different from the programming language used for specifying the infrastructure via IaC. The system allows users to specify a policy pack as a set of related policies—e.g., security policies, cost optimization policies, data location policy, and so on.

The system uses a uniform cloud resource model for representing resources, for example, cloud infrastructure. The uniform cloud resource model specifies various attributes including (1) organizations, teams, and users, (2) accounts, (3) resources, (4) resource versions, (5) metadata documents, (6) reference edges, (7) resource policy packs, and so on. Organizations, teams, and users are used for role based access control. An account acts as a container for resources. An organization may have many resources. A resource corresponds to a single physical or logical resource in an account. A resource version is a tuple of (version number, resource state). A metadata document is a (type name, JSON object) tuple that represents arbitrary metadata associated with an account, resource, or resource version. A reference edge represents a reference between two entities. A resource policy pack represents a set of policies that evaluate resources for conformance.

The system performs policy remediations to automatically fix violations. The system performs policy remediation using a uniform cloud resource model. The system runs the policy against the uniform cloud resource model and the policy generates a model of the changes needed. These changes are presented to the user as a change graph. The changes are then directly written back to the platform using the provider model which bypasses any IaC model that might or might not exist for the resources.

The policy remediation causes the system to alter and return resource properties. The system uses these new properties in place of the original ones passed to the remediation function. Following is an example resource policy remediation. Similar to resource validation, in TypeScript/JavaScript this example uses the remediateResourceOfType helper to filter and add strong typing.
def s3_no_public_read_remediator(args: ResourceValidationArgs):
   if args.resource_type==“aws:s3/bucket:Bucket” and “acl” in args.props:
      acl=args.props[“acl”]
      if acl==“public-read” or acl==“public-read-write”:
         #Modify the ACL and return the new bucket state to use instead.
         args.props[“acl”]=“private
         return args.props
s3_no_public_read=ResourceValidationPolicy(
   name=“s3-no-public-read”,
   description=“Prohibits publicRead/publicReadWrite permission on S3 buckets.”,
   enforcement_level=EnforcementLevel.REMEDIATE,
   remediate=s3_no_public_read_remediator,
)

According to an embodiment, the system runs all remediations before validation takes place. This ensures that no policy violations occur if a resource would have flagged a policy violation, were it not for a remediation. The system implements remediations in an order dependent manner because multiple remediations may mutate the same resource state. For organizations with many policy packs, the system may sort the policy packs in lexicographic order; and within a policy pack, the system may evaluate remediations in the order specified. The system thereby ensures there is always a deterministic, predictable order in remediations are executed.

### System Overview

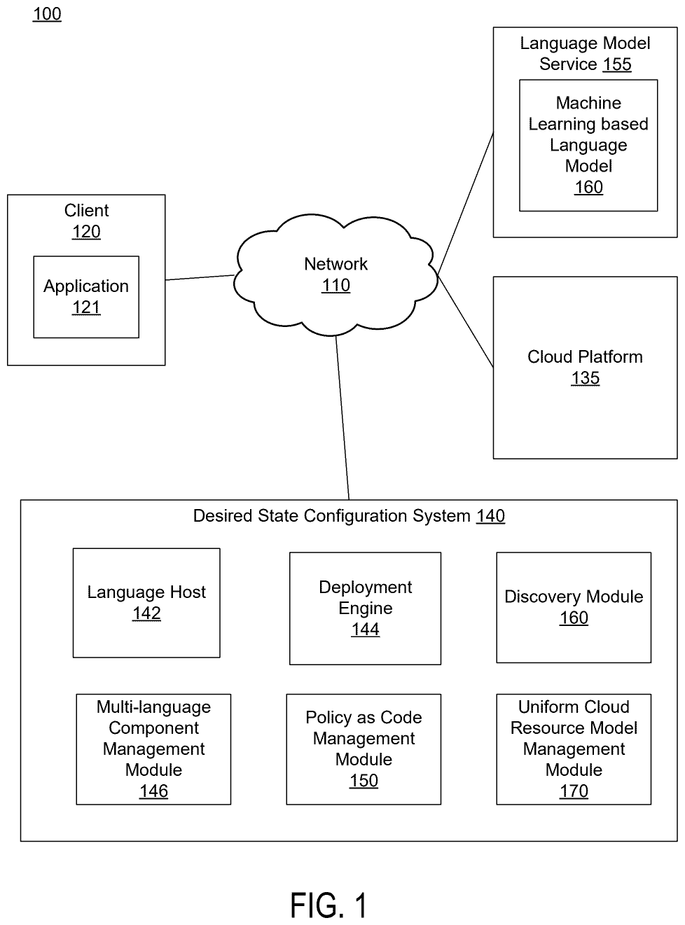

FIG. 1 shows a diagram of a system environment of a desired state configuration system, according to example embodiments. FIG. 1 shows a system environment 100 including, network 110, client device 120, a language model service 155, a cloud platform 135 and a desired state configuration system 140 that provides various services for users of client device 120 to manage infrastructure for an IT service. A cloud platform is also referred to herein as a cloud provider or a resource provider.

The network 110 may be any suitable communications network for data transmission. In some embodiments, the network 110 is the Internet and uses standard communications technologies and/or protocols. Thus, the network 110 can include links using technologies such as Ethernet, 802.11, worldwide interoperability for microwave access (WiMAX), 3G, 4G, digital subscriber line (DSL), asynchronous transfer mode (ATM), InfiniBand, PCI Express Advanced Switching, etc. Similarly, the networking protocols used on the network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 110 can be represented using technologies and/or formats including the hypertext markup language (HTML), the extensible markup language (XML), JavaScript Object Notation (JSON), etc. In addition, all or some of links can be encrypted using conventional encryption technologies such as the secure sockets layer (SSL), transport layer security (TLS), virtual private networks (VPNs), Internet Protocol security (IPsec), etc. In other embodiments, the entities use custom and/or dedicated data communications technologies instead of, or in addition to, the ones described above.

In one embodiment, client devices 120 communicate with desired state configuration system 140 through network 110. Client devices 120 generally include devices and modules for communicating with multi-language component management module 146 and a user of client device 120. Other components of a client device 120 may include display device, one or more computer processors, local fixed memory (RAM and ROM), as well as optionally removable memory (e.g., SD-card), power sources, and audio-video outputs. A client device 120 may also be referred to herein as the client.

In another embodiment, client device 120 may communicate with desired state configuration system 140 through an application or software module, such as application 121. The application 121 may be provided by desired state configuration system 140 for installation on client devices 120. Users of client device 120 may manage infrastructure of an IT service by using application 121 to access modules and resources provided by desired state configuration system 140. Application 121 may take various forms, such as a stand-alone application, an application plug-in, or a web console application (e.g., through webpages). Application 121 may generate an interface which is one means for performing this function.

Users of client devices 120 may wish to build an IT service with infrastructure including a set of resources with specific configurations (i.e. input parameters), and the specific configurations associated with the set of resources may be referred to as a desired state configuration for the infrastructure. For example, the user may specify a number of virtual machines connected with a number of storage units in a certain way described by a set of input parameters, and the set of input parameters associated with the infrastructure may be referred to as the desired state configuration for the infrastructure. The desired state configuration system 140 may be designed to manage the state of any sort of system, from operating system process state, to cloud-based infrastructure, to physical systems configuration. Users of client devices 120 may create computer programs (e.g., originating computer programs containing executable instructions) in supported programming languages such as Python, JavaScript, Go, and Typescript, etc. to manage resources provided by clout platform 135 through the application 121.

Cloud platform 135 may provide various cloud computing services or may be any other system that provides desired state configuration service to individuals and organizations. The cloud platform 135 may be referred to herein as cloud resource provider. Although embodiments are described in terms of cloud platforms or cloud resource providers, the techniques disclosed herein are applicable to any type of resource providers, including physical resource providers and component resource providers. Physical resource providers are providers that offer resources to individuals and organizations on demand and physical resource providers may manage resources on their own platforms. For example, AWS, Google Cloud, Azure, and Kubernetes are examples of physical resource providers that offer physical resources. Physical resources are resources offered and managed by physical resource providers, including but are not limited to processing power, virtual machines, data storage capacity, and networking. (The physical resources thus may include virtual resources, such as those of a cloud computing service, that ultimately correspond to a physical resource.) A user of the physical resource providers may manage state of a system through create, read, update and delete (also referred to as CRUD) operations to the physical resource providers. Component resource providers may be users of desired state configuration system 140 who are authors of component resources (also referred to as components). A component resource may be a logical grouping of resources, including both physical resources and component resources. For example, a component resource may include a physical resource and a child component resource that further includes multiple physical resources.

Desired state configuration system 140 includes a language host 142 that creates an environment for a program and executes the program, a deployment engine 144 that determines operations to be performed to reach a desired state configuration, a multi-language component management module 146 that manages reusable multi-language components, a policy as a code management module 150, a discovery module 160, and a uniform cloud resource model management module 170. A multi-language component is a reusable component that is authored in one language and may be used in an originating computer program written in a different supporting language. Desired state configuration system 140 may provide various modules and resources for managing infrastructure. The desired state configuration system 140 may support configuration for any system with a programmable interface, which could include physical systems, operating system state, etc. In the embodiment illustrated in FIG. 1, desired state configuration system 140 and the modules included are shown as a separate entity from client device 120, while in alternative embodiments, the modules may also be located locally on client device 120.

Language host 142 creates an environment for a program and executes the program in the environment generated for the program. Language host 142 may receive requests to launch a program that includes a set of parameters that describe a desired state configuration. Language host 142 may execute the program and launch an environment (e.g., runtime) based on the language in which the program is written. The language runtime prepares the program to be executed and detects necessary resource registrations. Language host 142 may notify respective cloud platforms 135 that may perform the necessary resource registration. When the new resources are registered, language host 142 sends a request to deployment engine 144 which further computes the operations needed to reach the desired state configuration.

Deployment engine 144 determines the operations to be performed to reach a desired state configuration from a given state configuration (e.g., the current state configuration of the system). Deployment engine 144 may receive a request from language host 142 indicating a list of resources needed for the desired state configuration. Deployment engine 144 receives the list and determines new resources to create and existing resources to delete based on the list of resources for desired state configuration and current state configuration. Deployment engine 144 may send remote procedure calls (RPCs) to cloud platforms 135 to perform operations (e.g., create, read, update, delete or CRUD operations) on physical resources. Thus, rather than achieving the desired state configuration by assembling that state from the starting point of a “blank slate,” the deployment engine 144 instead starts from (e.g.) the current state configuration of the system and makes only the changes needed to achieve the desired state configuration. This has a number of advantages over a “blank slate” approach (such as tearing down a given cloud environment and starting over each time the system is reconfigured), such as typically requiring far fewer computing operations to achieve, preserving the state of the system (e.g., data subsequently entered by customers into databases), and providing much greater system uptime.

Multi-language component management module 146 manages creation and construction (e.g., deployment) of multi-language components. For example, the client device 120 may author a multi-language component using resources and modules provided by multi-language component management module 146 in a first language (e.g., TypeScript) and the created component is available for another client device 120 to use in another configuration language (e.g., Python), which is achieved through the following process.

Multi-language component management module 146 may generate a software development kit (SDK) for each supported language (e.g., JavaScript, TypeScript, Python, Go, C#, F#, HCL) based on a schema of the component that client device 120 authored (e.g., in JSON, TypeScript, or other source forms). Client device 120, who wishes to use the component in another language, imports the SDK in one of the supported languages (e.g., Python). Client device 120 may use the SDK to create an instance of the component with a set of input parameters. The instance of the component may be created based on the structure of the component with different input parameters. Multi-language component management module 146 may construct the resources included in the component.

The policy as code (PaC) management module 150 allows users to specify policies as code. PaCs allow users to set guardrails to enforce compliance for resources so developers within an organization can provision their own infrastructure while sticking to best practices and security compliance. Using PaC, users can write flexible business or security policies. The PaC management module 150 allows administrators to enforce policies by defining and applying various rules to particular stacks within their organization. When policies are executed as part of deployments, any violation blocks that update from proceeding. According to an embodiment, the PaC management module 150 implements policy remediations that automatically fix policy violations that are detected.

The discover module 160 performs discovery of resources in the cloud infrastructure. The discovery module 160 allows the system to discover resources that may not have been defined using IaC. The discovery module 160 may discover new resources that are added or may determine that resources were removed or modified outside of the IaC infrastructure, for example, by using custom scripts or executing commands or APIs of the cloud infrastructure. The discovery module 160 informs the uniform cloud resource model management module 170 of any changes that are discovered.

The uniform cloud resource model management module 170 maintains a uniform cloud resource model of the resources in the cloud infrastructure. If the uniform cloud resource model management module 170 receives an indication of modifications to the resources that were discovered outside of the uniform cloud resource model, the uniform cloud resource model management module 170 modifies the uniform cloud resource model to incorporate the changes. For example, if a new resource was discovered that was not defined in the uniform cloud resource model, the uniform cloud resource model management module 170 modifies the uniform cloud resource model to add the discovered resource. If the uniform cloud resource model management module 170 determines that a resource was removed from the cloud infrastructure that is currently defined in the IaC, the uniform cloud resource model management module 170 removes the resource from the uniform cloud resource model. If the uniform cloud resource model management module 170 determines that the actual configuration of a resource was modified and does not match the configuration defined in the IaC, the uniform cloud resource model management module 170 modifies the uniform cloud resource model to match the configuration of the resource.

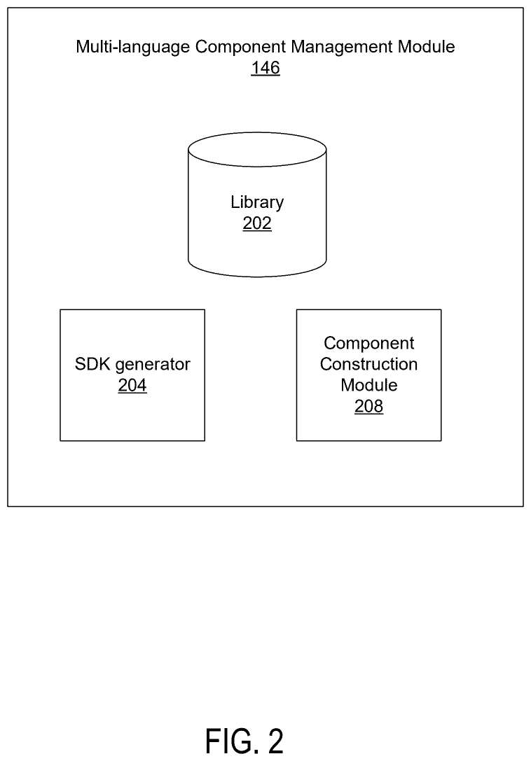

FIG. 2 illustrates one embodiment of a variety of modules included in a multi-language component management module 146. In one embodiment, multi-language component management module 146 includes a library 202 that stores resources available for clients 120 to use, an SDK generator 204 that generates SDKs for a multi-language component and a component construction module 208 that constructs components and resources for a desired state configuration.

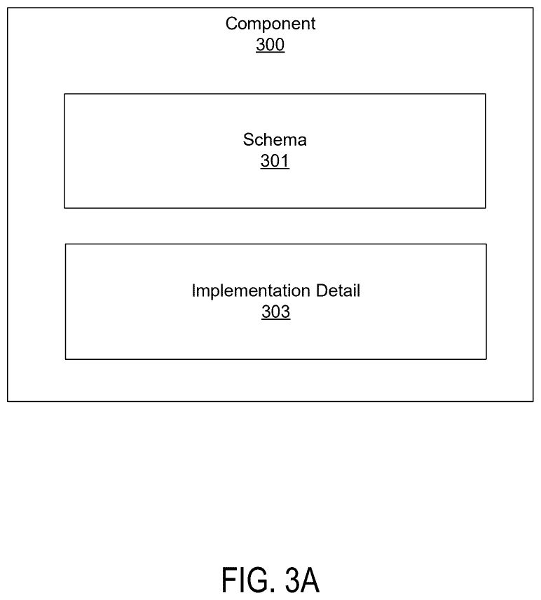

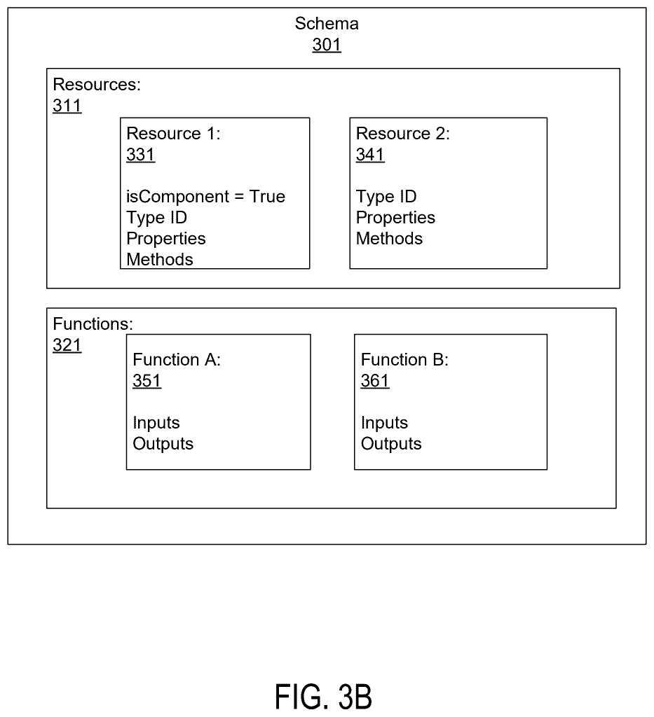

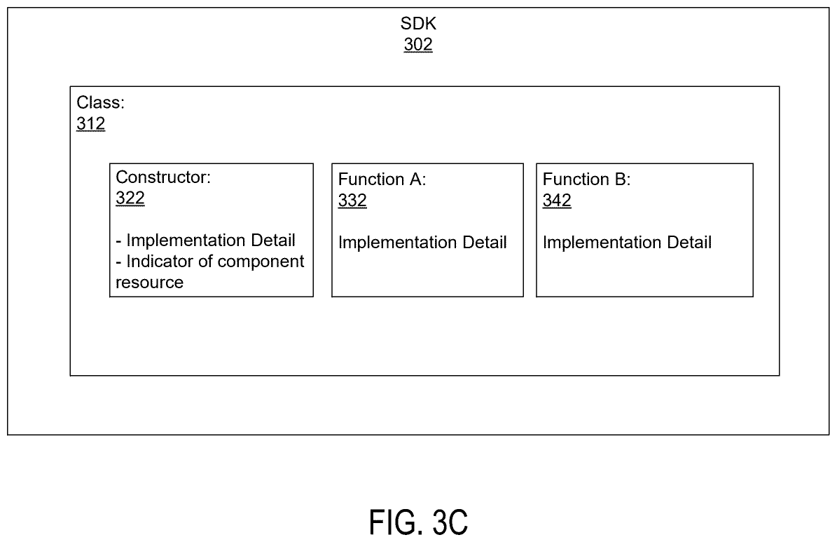

Library 202 stores libraries available for clients 120 to use to manage desired state configuration for an infrastructure. For example, library 202 may store reusable multi-language components that client device 120 may import and reuse. In one embodiment, client device 120 may author a reusable multi-language component that is published and saved in library 202. Library 202 may also store the generated SDKs associated with components. Client device 120 may reuse the component by importing an SDK generated by the multi-language component management module 146. For example, FIG. 3A illustrates one exemplary data structure for a component 300 including schema 301 and implementation detail 303, where the schema 301 may contain information that describes content included in the component 300 and implementation detail 303 contains details such as the child components included in the component 300 and how the child components are wired together. Schema 301 is discussed in further detail in accordance with FIG. 3B.

FIG. 3B illustrates one exemplary data structure of a schema for component 300. Schema 301 may include information associated with resources 311 and functions 321 that are included in component 300. In the exemplary data structure shown in FIG. 3B, component 300 includes resources 331 (resource 1) and 341 (resource 2), each resource including information associated with the respective resource such as TypeID, properties and methods. Resource 1 may have an indicator that indicates the resource is a component resource (i.e. dependent on additional resources). For example, resource 1 may have an indicator that says “isComponent=True.” SDK generator 204 may read this information and generate SDKs for the component resource. SDK generator 204 is discussed in further detail below. One concrete example of a set of related code for a simplified example component is provided below in Appendix A.

Referring back to FIG. 2, SDK generator 204 generates SDKs for a multi-language component. In one embodiment, SDKs are generated based on a schema of a multi-language component, such as the one illustrated in FIG. 3B. Based on the indicator in resource 1 (FIGS. 3B, 331) that says “isComponent=True,” SDK generator 204 may process this information and include in the generated SDK a similar indicator indicating that the resource is a component resource. For example, FIG. 3C illustrates an exemplary SDK 302 generated based on schema 301 presented in FIG. 3B. The SDK 302 is for illustration purposes, while in reality a generated SDK may include more information such as libraries imported, additional classes and additional functions. The SDK generator 204 may generate an SDK for each supported language (e.g., JavaScript, TypeScript, Python, Go, C#, F#, HCL) based on the component 300. Therefore, structure and content of SDK 302 may also vary depending on the language that the SDK is generated in.

Continuing with the discussion of the structure of SDK 302 in FIG. 3C, SDK 302 may include class 312 with a constructor function 322 that constructs an instance of the component 300. Class 312 may also include function A 332 and function B 342, which are also included in the schema 301 in FIG. 3B. Implementation details of function A 332 and function B 342 may be defined in the implementation detail 303 in FIG. 3A. SDK generator 204 may generate an indicator in constructor 322 indicating that component 300 is a component resource because the component 300 depends on additional resources such as resources 331 (resource 1) and 341 (resource 2) as shown in FIG. 3B.

The multi-language component management module 146 can generate an SDK for different supported configuration language. A client device 120 may author a component in a first language L1 (e.g., TypeScript). In one embodiment the component may include a schema that describes information associated with the content in the component. Client device 120 may author the component via an interface provided by application 121 and publish the component in the multilanguage component management module 146 via application 121. Multi-language component management module 146 may create SDKs in a variety of supported languages such as JavaScript, TypeScript, Python, Go, C#, F#, and HCL. In one embodiment multi-language component management module 146 may publish the SDKs to respective package managers such as Node Package Manager (npm). Client device 120 may wish to use the component in a second language L2 such as Python. Client device 120 may download and import the SDK in Python via application 121. Client device 120 may request to generate an instance of the component in a program that client device 120 authors, specifying a set of input parameters that describe a desired state configuration for the component that client device 120 wishes to construct.

### Policy as Code

The system allows users to specify policies as code. The policies are installed and executed to determine whether there are any policy violations. The system allows users to set guardrails to enforce compliance for resources so developers within an organization can provision their own infrastructure while using best practices and security compliance. Using Policy as Code, users can write flexible business or security policies. The system allows organization administrators to apply these rules or policy constraints to particular stacks within their organization. When policies are executed as an IaC deployments, the system gates or blocks an update from proceeding if the update is likely to cause policy violations.

The system performs automatic remediation of policies by making changes to the infrastructure that are necessary to enforce a policy that is being violated. Furthermore, the system performs discovery of cloud infrastructure to identify all resources of the infrastructure by invoking read APIs of the cloud infrastructure. The infrastructure identified via discovery as well as infrastructure specified as IaC are represented using the uniform resource model 410. The system executes policies specified using PaC against both uniform cloud resource model and infrastructure discovered using the discovery process that may identify resource not specified via IaC. The system performs policy remediation against both infrastructure specified as uniform cloud resource model as well as infrastructure identified via discovery. The system may discover at least some of the set of computing resources from the cloud platform by invoking application programming interfaces (APIs) of the cloud platform. The system uses the discovery process to identify computing resources from the cloud platform that may not be specified using an IaC specification. The system generates the IaC specification for such discovered computing resources from the cloud platform and adds the generated IaC specification to the existing IaC specification.

According to an embodiment, the system receives and stores a PaC specification of a policy associated with computing resources of a cloud infrastructure of a cloud platform. The policy as code specification comprises a set of policy constraints. If a policy constraint is not satisfied, the system determines that the policy if violated. The system stores metadata describing a set of computing resources of the cloud infrastructure. The metadata is represented using the uniform cloud resource model of the set of computing resources that represents computing resources specified as IaC as well as computing resources not specified as IaC. The system executes the PaC specification against the metadata describing the set of computing resources. If the execution of the PaC specification indicates indicating a failure to satisfy at least a policy constraint from the set of policy constraints, the system determines a policy violation based on execution of the PaC specification.

According to an embodiment, the system performs automatic remediation of the policy violation. The system determines a modification to the uniform cloud resource model representing the set of computing resources such that the modification remediates the policy violation. According to an embodiment, the system uses a machine learning based model, for example, a large language model (LLM) to determine the required modification to the uniform cloud resource model for remediating the policy violation. The machine learning based model may be a transformer based neural network that is trained using large corpus of text input as well as using examples of IaC and PaC specifications using various programming languages. The machine learning based model may be pretrained using publicly available natural language text, for example, the web and is finetuned using examples of PaC specification and IaC specification using various programming languages described herein. For example, the system generates a prompt describing the policy violation and including the PaC specification and requesting the machine learning based model to determine the required modification for remediation of the policy violation. The system obtains the modified code from the response obtained by executing the machine learning based language model.

According to an embodiment, the system recommends the modification to the PaC specification for remediation of the policy violation and proceeds to implement the modifications responsive to receiving an approval from a user. Alternatively, the system automatically proceeds to implement the modifications to the PaC specification. Accordingly, the system executes the modified uniform cloud resource model. The execution of modified uniform cloud resource model causes changes to the set of computing resources such that the changes remediate the policy violation.

The system may receive a request to modify the infrastructure from a user and block the request to update if the update is likely to cause a policy violation. For example, assume the system receives a modification M2 performed by a user by changing the IaC specification. The system may remediate the policy violation V1. Subsequently, the system receives a second modification M2 to the uniform cloud resource model. The modification M2 may be caused by a user request to modify the IaC. The system executes the policy as code specification against the PaC as modified by the second modification M2. The system detects a second policy violation V2 that is expected to be caused by executing the second modification M2. Accordingly, the system performs code analysis of the IaC as modified by the second modification M2 to determine whether the resulting IaC will cause a policy violation. Responsive to detecting the second policy violation V2 the system blocks an update based on the uniform cloud resource model modified according to the modification M2. The system may rollback changes to the system that may have ben propagated as a result of modification M2 to the IaC.

If a modification to IaC is determined to not cause any policy violation, the system proceeds with implementing the IaC modification. For example, the system receives a third modification M3 to the uniform cloud resource model. The system executes the policy as code specification against the third modificationM2 and checks if the third modification causes any policy violations. Responsive to detecting no policy violations resulting from the third modification M3, the system proceeds with the updates to the cloud infrastructure according to the uniform cloud resource model as modified according to M3.

According to an embodiment, the system executes the PaC specification on a regular basis to determine whether any policy violation occurred. For example, the system configuration may change over time as a result of system being reconfigured outside of the IaC via directly invoking of APIs of the cloud platform. The system attempts to catch such policy violations that may occur as a result. Accordingly, the system schedules the PaC specification for execution periodically and executes the PaC specification according to the schedule to determine whether there are policy violations.

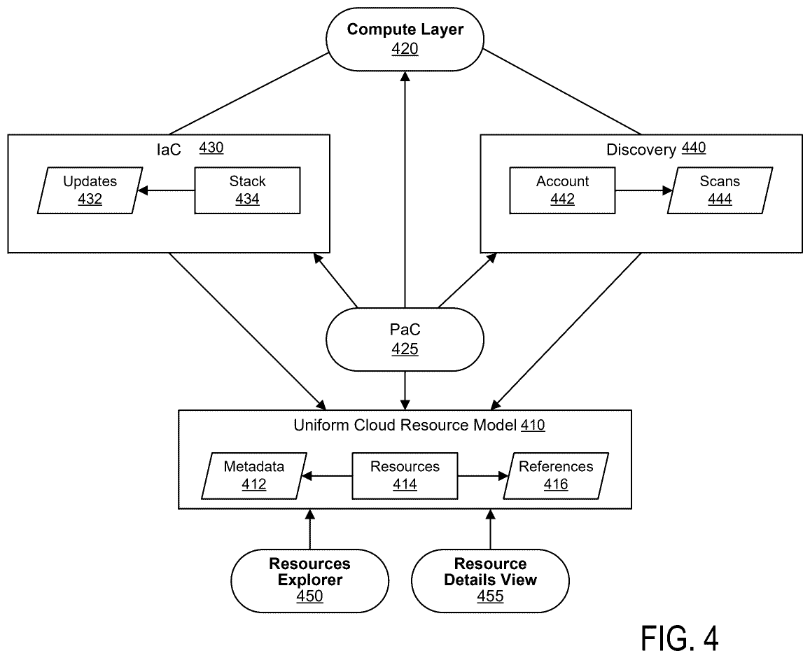

FIG. 4 shows the overall architecture of the system and interactions between components, according to an embodiment. The uniform resource model 410 includes information describing various resources 414 including metadata 412 and references 416. The uniform resource model 410 described various components including organizations, teams, users, accounts, resources, and so on. The resources explorer 450 and resource details view 455 allow a user such as a system administrator to view and explore the uniform resource model 410. The desired configuration of a system may be specified using the IaC 430. The system configures the physical resources to map the IaC 430 to the cloud infrastructure, thereby making sure that the cloud infrastructure maps to the IaC specification. For example, changes to the IaC result in the system triggering actions that reconfigure the cloud infrastructure to get modified and correspond to the modified IaC specification.

The PaC 425 is defined based on uniform resource model 410. The IaC 430 is also defined based on the uniform resource model 410. The IaC 430 includes stacks 434. Updates 432 are performed based on the stack 434. A stack 434 is a logical container of resources that are typically managed and deployed together. Updates 432 makes modifications to the stack 434. The update 432 process determines the difference (delta) between the current IaC and the modified IaC as a result of an update and applies the changes to the resources to make the resources match the modified IaC 430.

The computer layer 420 is a mechanism for performing various tasks including discovery 440, policies specified using PaC 425, and portions of IaC 430. The computer layer 420 also manages rate limits. For example, it handles discovery by enumerating various resources with a particular scope, for example, all cloud resources for an AWS account and region. The computer layer 420 also executes policies using the PaC 425 specifications. The PaC 425 component may stop an update 432 from execution if the update is likely to cause violations of a policy thereby stopping the process of pushing the changes to the IaC to the physical cloud resources.

The system performs discovery 440 to identify resources by calling read methods of various providers to identify the resources available within a scope, for example, an account. According to an embodiment, the representation of the cloud infrastructure obtained by the discovery process is converted into the uniform resource model 410 which is platform independent. The PaC 425 is based on the uniform resource model 410 and is also specified independent of platform.

An organization may or may not have an IaC 430 based on the uniform resource model 410. If an organization maintains an IaC 430 for managing their cloud IN embodiments, where an organization maintains an IaC 430, a user, for example, a system administrator may modify the cloud infrastructure outside the IaC 430 specification, thereby causing the cloud infrastructure to become different from the IaC 430 specification. The discovery is performed for various accounts 442 and comprises performing scans 444 of the infrastructure to identify the various resources. The system implements an event based mechanism that triggers policy executions in response to (1) scans 444 as resources are discovered or (2) if a resource is modified for example either by modifying IaC or outside of IaC in the case where resources are not IaC managed.

The system performs discovery 440 to identify available resources in the cloud infrastructure. If an organization maintains an IaC 430 specification, the available resources may be compared with the IaC 430 specification to determine whether the two match.

A policy is installed by transmitting the PaC to a storage location where the compute engine can locate the code corresponding to the PaC and execute it. The system collects information describing all policy packs and displays their information via a user interface. A user can select one or more policies or policy packs and execute them against a set of resources or schedule them for execution at a particular time or on a periodic basis. Accordingly, the user interface allows users to find all policy packs, display them, map them to sets of resources, and instruct the system to execute the policy packs against corresponding sets of resources as well as specify when the policy packs are executed.

According to an embodiment, the system performs policy remediations by modifying the cloud infrastructure so that the modified cloud infrastructure conforms to the policies. The system determines changes needed to the cloud infrastructure to conform to the polices and shows the changes to the user as a visual diff graph. The changes are then written back to the platform provider's write method. Accordingly, PaC maintains and enforces policies using the uniform cloud resource model 410 (logical representation of cloud resources) as well as via discovery 440 that discovers the physical resources of the cloud infrastructure. The PaC also identifies possible ways to fix the policy violation and shows the strategy for fixing the policy violation to the user for approval. If the user approves the strategy, the PaC applies recommended changes to the cloud infrastructure to fix the problems encountered via discovery 440. Accordingly, the system modifies the cloud infrastructure to remediate the policy violations.

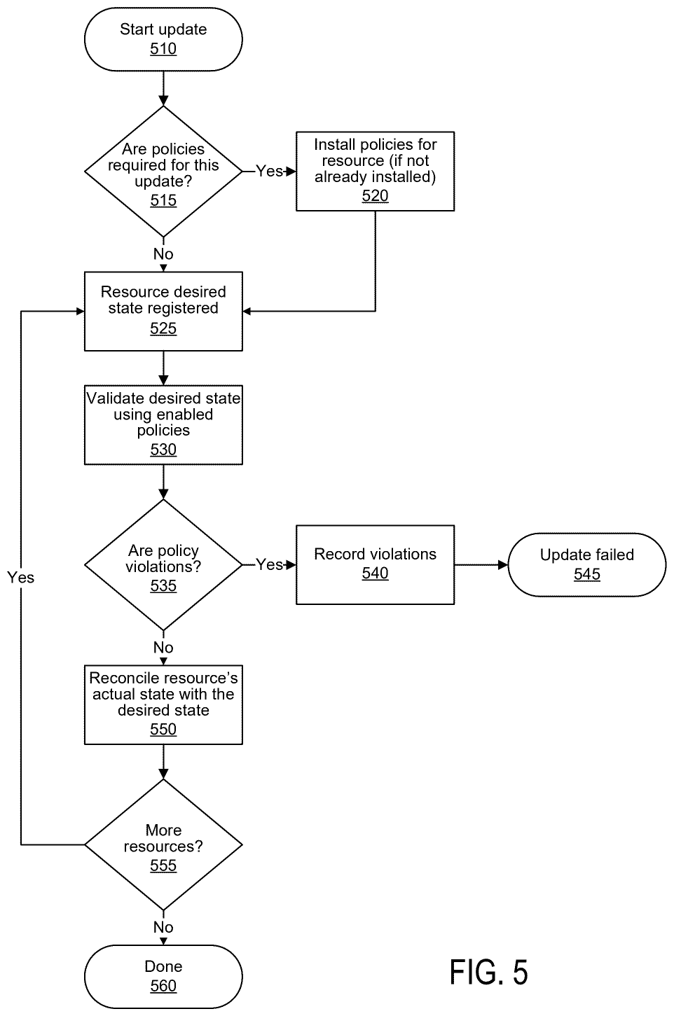

The steps of the following processes illustrated in FIGS. 5-7 are executed by a system, for example, the desired state configuration system 140.

FIG. 5 is a flowchart illustrating the process for applying updates while enforcing policies, according to an embodiment. The system receives a request to start an update 510 based on IaC. The system determines 515 whether any policies are required for the update. If polies are required for this update, the system installs 520 the required policies if they are not already installed. The system registers 525 resources of the desired state. The system validates 530 desired state using enabled policies. The system determines 535 whether there are any policy violations. If there are policy violations, the system records 540 the violations. The system causes the update to fail 545. If system determines 535 that there are no policy violations, the system reconciles 550 the resource's actual state with the desired state. The system checks 555 if there are more resources. If there are more resources, the system repeats the above states 525, 530, 535, and 540, 545 or 550, 555. If the system determines 555 that there are no more resources, the system completes 560 the update.

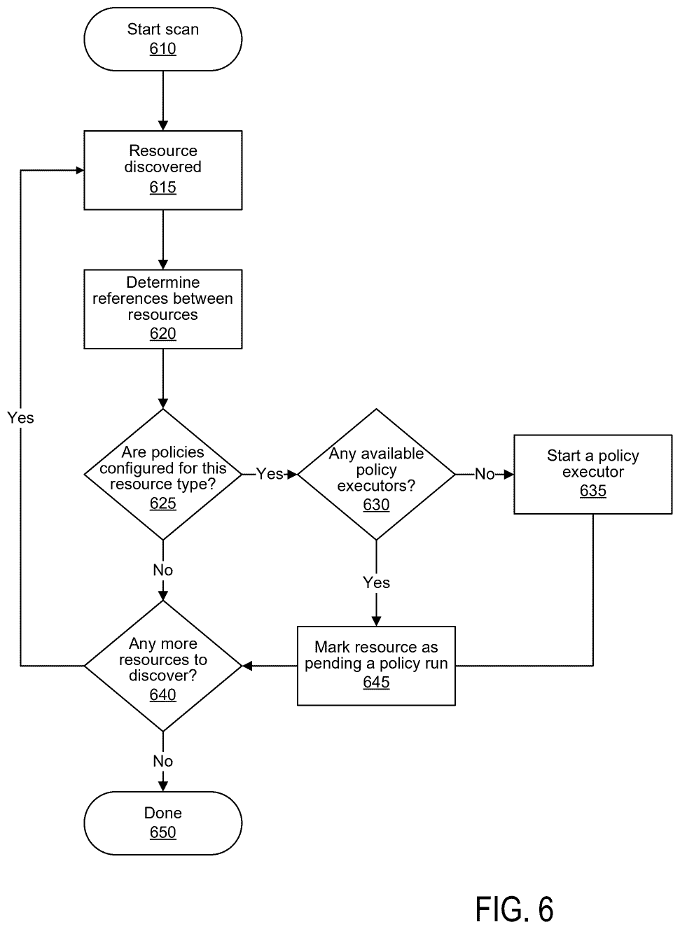

FIG. 6 is a flowchart illustrating the process for discovering resources while enforcing policies, according to an embodiment. The system receives a request to start 610 a scan. The system discovers 615 a resource. The system determines 620 references between resources. The system determines 625 whether there are any policies configured for this resource type. If the system determines 625 that there are policies configured for this resource type, the system determines 630 whether there are any available policy executors. If the system determines 630 that there are no policy executors available, the system starts 635 a policy executor. If the system determines 630 that there are policy executors available, the system marks 645 the resource as pending in a policy run. The system determines 640 whether there are more resources to discover. If the system determines 640 that there are more resources to discover, the system repeats the steps 615, 620, 625, 640 or 630, 635, and 645. If the system determines 640 that there are no more resources to discover, the system completes 650 the discovery process.

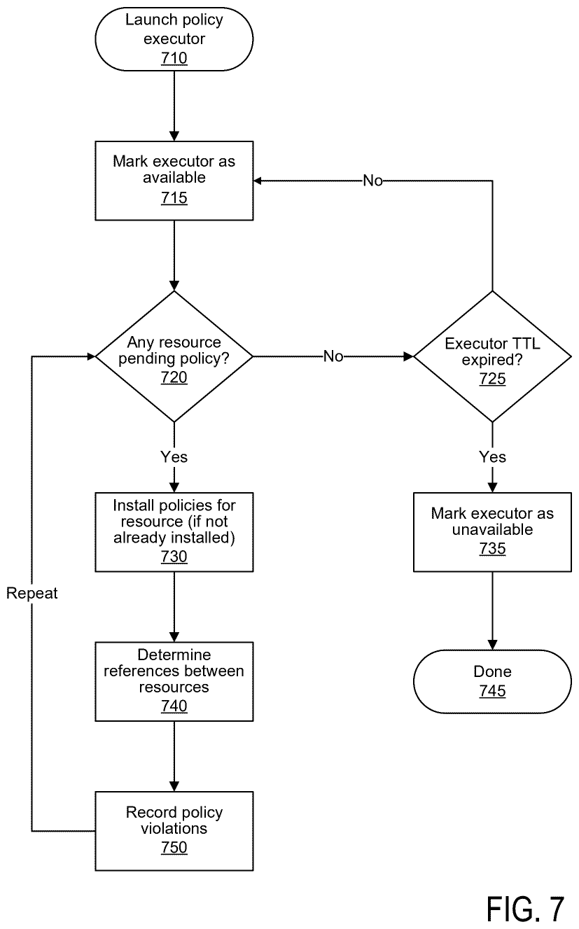

FIG. 7 is a flowchart illustrating the process for execution of policies, according to an embodiment. The system launches 710 a policy executor. The system marks 715 the executor as available. The system determines 720 if any resource has pending policies. If system determines 720 that there are no resources pending policies, the system checks 725 if the executor TTL (time to live) has expired. If the system determines 725 that the executor TTL has not expired, the system repeats the step 715. If system determines 720 that there are resources pending policies, the system installs 730 the policies for the resource if they are not already installed. The system determines 740 references between resources. The system records 750 policy violations and repeats steps 720, 730, 740, 750 or 725, 735, and 745.

If the system determines 725 that the executor TTL has expired, the system marks 735 the executor as unavailable and completes 645 the process.

### User Interface

The system reports policy violations when the system's stack fails to comply with the policies defined in policy packs. The system logs these violations during deployments and can either block the update if the enforcement level is specified as mandatory or issue a warning if the enforcement level is specified as advisory. According to an embodiment, the system shows all violations via a user interface, for example, a dashboard. The user interface may provide a centralized view of all violations across an organization, and allows user to filter and group violations by various criteria such as policy pack, project, stack, and enforcement level.

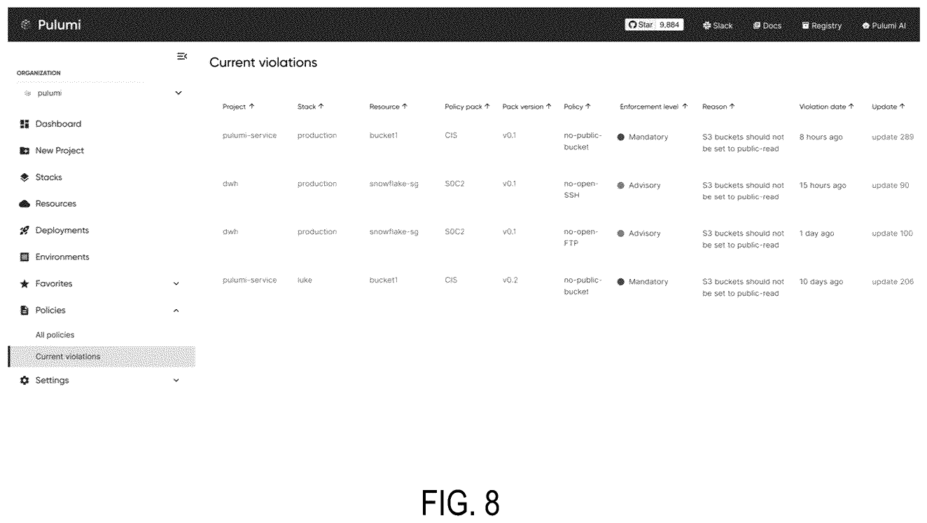

FIG. 8 shows a screenshot of a user interface displaying policy violations of an organization, according to an embodiment. A policy violations user interface may show information including name of policy that was violated, resource name and resource type associated with the violations, enforcement level, reason why policy was violated, time of occurrence of violation, and so on. The user interface shows all the policy violations of the organization on a single page. According to an embodiment, the system generates high-level summaries based on policy violations. The summaries show information such as the types of resources that have policy violations, the policy packs associated with policy violations, and so on. According to an embodiment, the user interface allows grouping based on various attributes such as project, stack, policy name, policy pack name, violation date, and so on.

### Additional Considerations

Reference in the specification to “one embodiment” or to “an embodiment” means that a particular feature, structure, or characteristic described in connection with the embodiments is included in at least one embodiment. The appearances of the phrase “in one embodiment” in various places in the specification are not necessarily all referring to the same embodiment.

In this description, the term “module” refers to a physical computer structure of computational logic for providing the specified functionality. A module can be implemented in hardware, firmware, and/or software. In regard to software implementation of modules, it is understood by those of skill in the art that a module comprises a block of code that contains the data structure, methods, classes, header and other code objects appropriate to execute the described functionality. Depending on the specific implementation language, a module may be a package, a class, or a component. Languages that formally support the modules include Ada, Algol, BlitzMax, COBOL, D, Dart, Erlang, F, Fortran, Go, Haskell, IBM/360 Assembler, IBM i Control Language (CL), IBM RPG, Java, MATLAB, ML, Modula, Modula-2, Modula-3, Morpho, NEWP, JavaScript, Oberon, Oberon-2, Objective-C, OCaml, several derivatives of Pascal (Component Pascal, Object Pascal, Turbo Pascal, UCSD Pascal), Perl, PL/I, PureBasic, Python, and Ruby, though other languages may support equivalent structures using a different terminology than “module.”

It will be understood that the named modules described herein represent one embodiment of such modules, and other embodiments may include other modules. In addition, other embodiments may lack modules described herein and/or distribute the described functionality among the modules in a different manner. Additionally, the functionalities attributed to more than one module can be incorporated into a single module. Where the modules described herein are implemented as software, the module can be implemented as a standalone program, but can also be implemented through other means, for example as part of a larger program, as a plurality of separate programs, or as one or more statically or dynamically linked libraries. In any of these software implementations, the modules are stored on the computer readable persistent storage devices of a system, loaded into memory, and executed by the one or more computer processors of the system's computers.

The operations herein may also be performed by an apparatus. This apparatus may be specially constructed for the required purposes, or it may comprise a general-purpose computer selectively activated or reconfigured by a computer program stored in the computer. Such a computer program may be stored in a non-transitory, tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present technology is not described with reference to any particular programming language. It will be appreciated that a variety of programming languages may be used to implement the teachings of the present technology as described herein, and any references below to specific languages are provided for disclosure of enablement and best mode of the present technology.

While the technology has been particularly shown and described with reference to a preferred embodiment and several alternate embodiments, it will be understood by persons skilled in the relevant art that various changes in form and details can be made therein without departing from the spirit and scope of the technology.

Finally, it should be noted that the language used in the specification has been principally selected for readability and instructional purposes and may not have been selected to delineate or circumscribe the inventive subject matter. Accordingly, the disclosure of the present technology is intended to be illustrative, but not limiting, of the scope of the technology, which is set forth in the following claims.

What is claimed is:

1. A computer-implemented method for enforcing policies based on a computing infrastructure of a cloud platform, the computer-implemented method comprising:
storing a policy as code specification of a policy associated with computing resources of a cloud infrastructure of a cloud platform, the policy as code specification comprising a set of policy constraints;
storing metadata describing a set of computing resources of the cloud infrastructure, the metadata represented using a uniform cloud resource model of the set of computing resources;
executing the policy as code specification against the metadata describing the set of computing resources;
determining a policy violation based on execution of the policy as code specification, the policy violation indicating a failure to satisfy at least a policy constraint from the set of policy constraints;
determining a modification to the uniform cloud resource model representing the set of computing resources, the modification recommended for remediation of the policy violation; and
executing a modified uniform cloud resource model, the execution causing changes to the set of computing resources, the changes remediating the policy violation.

2. The computer-implemented method of claim 1, wherein the set of computing resources is discovered from the cloud platform by invoking application programming interfaces (APIs) of the cloud platform.

3. The computer-implemented method of claim 1, wherein the modification to the uniform cloud resource model is a first modification and the policy violation is a first policy violation, further comprising:
receiving a second modification to the uniform cloud resource model;
executing the policy as code specification against the second modification to the uniform cloud resource model;
detecting a second policy violation expected from executing the second modification to the uniform cloud resource model; and
responsive to detecting the second policy violation, blocking an update based on the uniform cloud resource model modified according to the second modification.

4. The computer-implemented method of claim 1, wherein the modification to the uniform cloud resource model is a first modification and the policy violation is a first policy violation, further comprising:
receiving from a user a third modification to the uniform cloud resource model;
executing the policy as code specification against the third modification to the uniform cloud resource model; and
responsive to detecting no policy violations resulting from the third modification to the uniform cloud resource model, updating the cloud infrastructure according to the uniform cloud resource model modified according to the third modification.

5. The computer-implemented method of claim 1, wherein the uniform cloud resource model comprises metadata describing resources and relationships between resources.

6. The computer-implemented method of claim 1, further comprising:
responsive to building the uniform cloud resource model representing the set of computing resources, auditing one or more actions performed using the uniform cloud resource model.

7. The computer-implemented method of claim 1, further comprising:
scheduling the policy as code specification for execution periodically; and
responsive to scheduling the policy as code specification for execution periodically, executing the policy as code specification according to the schedule to determine whether there are policy violations.

8. A non-transitory computer-readable storage medium storing executable computer instructions that, when executed by one or more computer processors, cause the one or more computer processors to perform steps for enforcing policies based on a computing infrastructure of a cloud platform, the steps comprising:
storing a policy as code specification of a policy associated with computing resources of a cloud infrastructure of a cloud platform, the policy as code specification comprising a set of policy constraints;
storing metadata describing a set of computing resources of the cloud infrastructure, the metadata represented using a uniform cloud resource model of the set of computing resources;
executing the policy as code specification against the metadata describing the set of computing resources;
determining a policy violation based on execution of the policy as code specification, the policy violation indicating a failure to satisfy at least a policy constraint from the set of policy constraints;
determining a modification to the uniform cloud resource model representing the set of computing resources, the modification recommended for remediation of the policy violation; and
executing a modified uniform cloud resource model, the execution causing changes to the set of computing resources, the changes remediating the policy violation.

9. The non-transitory computer-readable storage medium of claim 8, wherein the set of computing resources is discovered from the cloud platform by invoking application programming interfaces (APIs) of the cloud platform.

10. The non-transitory computer-readable storage medium of claim 8, wherein the modification to the uniform cloud resource model is a first modification and the policy violation is a first policy violation, wherein the instructions cause the one or more computer processors to further perform steps comprising:
receiving a second modification to the uniform cloud resource model;
executing the policy as code specification against the second modification to the uniform cloud resource model;
detecting a second policy violation expected from executing the second modification to the uniform cloud resource model; and
responsive to detecting the second policy violation, blocking an update based on the uniform cloud resource model modified according to the second modification.

11. The non-transitory computer-readable storage medium of claim 8, wherein the modification to the uniform cloud resource model is a first modification and the policy violation is a first policy violation, wherein the instructions cause the one or more computer processors to further perform steps comprising:
receiving from a user a third modification to the uniform cloud resource model;
executing the policy as code specification against the third modification to the uniform cloud resource model; and
responsive to detecting no policy violations resulting from the third modification to the uniform cloud resource model, updating the cloud infrastructure according to the uniform cloud resource model modified according to the third modification.

12. The non-transitory computer-readable storage medium of claim 8, wherein the uniform cloud resource model comprises metadata describing resources and relationships between resources.

13. The non-transitory computer-readable storage medium of claim 8, wherein the instructions cause the one or more computer processors to further perform steps comprising:
responsive to building the uniform cloud resource model representing the set of computing resources, auditing one or more actions performed using the uniform cloud resource model.

14. The non-transitory computer-readable storage medium of claim 8, wherein the instructions cause the one or more computer processors to further perform steps comprising:
scheduling the policy as code specification for execution periodically; and
responsive to scheduling the policy as code specification for execution periodically, executing the policy as code specification according to the schedule to determine whether there are policy violations.

15. A computer system comprising:
one or more computer processors configured to execute instructions; and
a non-transitory computer-readable storage medium storing executable computer instructions that, when executed by one or more computer processors, cause the one or more computer processors to perform steps for enforcing policies based on a computing infrastructure of a cloud platform, the steps comprising:
storing a policy as code specification of a policy associated with computing resources of a cloud infrastructure of a cloud platform, the policy as code specification comprising a set of policy constraints;
storing metadata describing a set of computing resources of the cloud infrastructure, the metadata represented using a uniform cloud resource model of the set of computing resources;
executing the policy as code specification against the metadata describing the set of computing resources;
determining a policy violation based on execution of the policy as code specification, the policy violation indicating a failure to satisfy at least a policy constraint from the set of policy constraints;
determining a modification to the uniform cloud resource model representing the set of computing resources, the modification recommended for remediation of the policy violation; and
executing a modified uniform cloud resource model, the execution causing changes to the set of computing resources, the changes remediating the policy violation.

16. The computer system of claim 15, wherein the modification to the uniform cloud resource model is a first modification and the policy violation is a first policy violation, wherein the instructions cause the one or more computer processors to further perform steps comprising:
receiving a second modification to the uniform cloud resource model;
executing the policy as code specification against the second modification to the uniform cloud resource model;
detecting a second policy violation expected from executing the second modification to the uniform cloud resource model; and
responsive to detecting the second policy violation, blocking an update based on the uniform cloud resource model modified according to the second modification.

17. The computer system of claim 15, wherein the modification to the uniform cloud resource model is a first modification and the policy violation is a first policy violation, wherein the instructions cause the one or more computer processors to further perform steps comprising:
receiving from a user a third modification to the uniform cloud resource model;
executing the policy as code specification against the third modification to the uniform cloud resource model; and
responsive to detecting no policy violations resulting from the third modification to the uniform cloud resource model, updating the cloud infrastructure according to the uniform cloud resource model modified according to the third modification.

18. The computer system of claim 15, wherein the uniform cloud resource model comprises metadata describing resources and relationships between resources.

19. The computer system of claim 15, wherein the instructions cause the one or more computer processors to further perform steps comprising:
responsive to building the uniform cloud resource model representing the set of computing resources, auditing one or more actions performed using the uniform cloud resource model.

20. The computer system of claim 15, wherein the instructions cause the one or more computer processors to further perform steps comprising:
scheduling the policy as code specification for execution periodically; and
responsive to scheduling the policy as code specification for execution periodically, executing the policy as code specification according to the schedule to determine whether there are policy violations.
